(19) United States
(12) Patent Application Publication
(10) Pub. No.: US 2014/0175067 A1
(43) Pub. Date: Jun. 26, 2014

(54) METHODS OF FORMING IMAGES BY LASER MICROMACHINING

(71) Applicant: ELECTRO SCIENTIFIC INDUSTRIES, INC., Portland, OR (US)

(72) Inventors: Robert Reichenbach, Portland, OR (US); Jeffrey Howerton, Portland, OR (US); Hisashi Matsumoto, Hillsboro, OR (US); Fang Shan, San Jose, CA (US); Michael Shane Noel, Portland, OR (US)

(73) Assignee: ELECTRO SCIENTIFIC INDUSTRIES, INC., Portland, OR (US)

(21) Appl. No.: 14/135,097

(22) Filed: Dec. 19, 2013

Related U.S. Application Data
(60) Provisional application No. 61/740,430, filed on Dec. 20, 2012.

(51) Int. Cl. B23K 26/00; B23K 26/36; B23K 26/06

(52) U.S. Cl. CPC B23K 26/0066; B23K 26/0626; B23K 26/0639; B23K 26/365
USPC 219/121.61; 219/121.69

(57) ABSTRACT

A method and laser processing system (2) addresses a substrate (102) with three different sets of laser processing parameters to achieve different surface effects in the substrate (102). A first set of laser parameters is employed to form a recess (106) in the substrate. A second set of laser parameters is employed to polish a surface (108) of the recess (106). A third set of laser parameters is employed to modify a polished surface (108) of the recess (106) to have optical characteristics that satisfy conditions for a desirable visual appearance.

### CROSS REFERENCE TO RELATED APPLICATIONS

This application is a Non-Provisional application of U.S. Provisional Application No. 61/740,430, which was filed on Dec. 20, 2012, the contents of which are herein incorporated by reference in their entirety for all purposes.

### COPYRIGHT NOTICE

© 2013 Electro Scientific Industries, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This application relates to laser processing and, in particular, to systems, methods, and apparatuses for processing a material with different sets of laser processing parameters to achieve different surface effects in the material.

### SUMMARY

In some embodiments, a method or a laser system addresses a substrate with different sets of laser processing parameters to achieve different surface effects in the substrate.

In some embodiments, a first set of recess forming laser parameters can be employed to form a recess in the substrate. A second set of polishing laser parameters can be employed to polish a surface of the recess. A third set of surface modification laser parameters can be employed to modify a polished surface of the recesses to have optical characteristics that satisfy conditions for a desirable visual appearance.

In some embodiments, the sets of parameters each contain a parameter having at least one different value than that of the other sets.

In some embodiments, the third set of surface modification laser parameters may include different sets of laser parameters to provide different optical characteristics that satisfy conditions for different desirable visual appearances.

### BRIEF DESCRIPTION OF THE DRAWINGS

FIG. 1 schematically illustrates one embodiment of a process of forming an image in an article.

FIG. 2 schematically illustrates another embodiment of a process of forming an image in an article.

FIG. 3 schematically illustrates yet another embodiment of a process of forming an image in an article.

FIGS. 3A and 3B are front and side elevation views of an image in an article formed by the process represented by FIG. 3.

FIG. 4 schematically illustrates still another embodiment of a process of forming an image in an article.

FIGS. 4A and 4B are front and side elevation views of an image in an article formed by the process represented by FIG. 4.

FIGS. 5A and 5B illustrate an exemplary laser processing system.

FIG. 6. is a schematic diagram emphasizing certain components of the laser processing system of FIGS. 5A and 5B.

FIG. 7. is an enlarged representation of a beam waist of laser output produced by the laser processing system.

### DETAILED DESCRIPTION OF EMBODIMENTS

Example embodiments are described below with reference to the accompanying drawings. Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of components may be exaggerated for clarity. The terminology used herein is for the purpose of describing particular example embodiments only and is not intended to be limiting. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween.

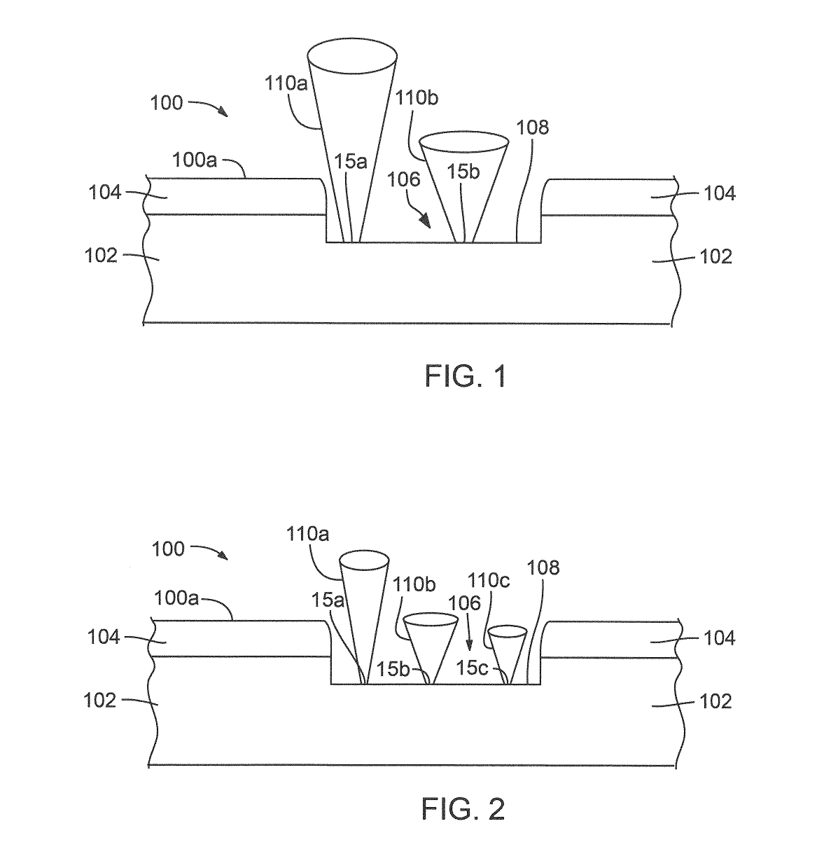

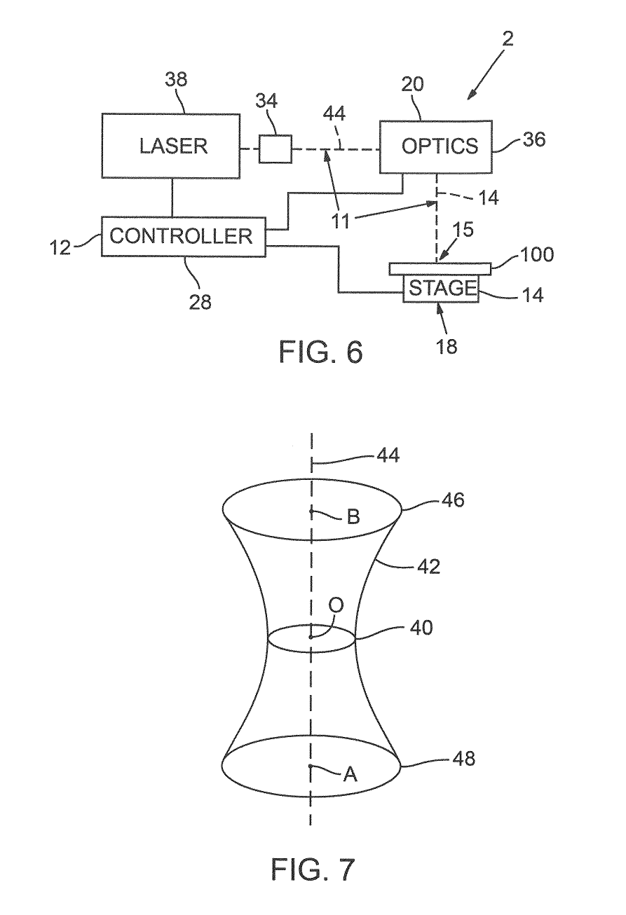

FIG. 1 schematically illustrates one embodiment of a process of forming an image in an article. With reference to FIG. 1, an article 100 having a surface 100a with a preliminary visual appearance may be machined using a beam 110a of laser pulses 11 (FIG. 6) having laser engraving parameters to form a character or image having a modified visual appearance that is different from the preliminary visual appearance. In the illustrated embodiment, the article 100 includes a substrate 102 (e.g., formed of aluminum or an aluminum alloy) and a layer 104 (e.g., formed of aluminum oxide) disposed on a surface of the substrate 102. The surface 100a of the article 100 or of the substrate 102 may be smooth or may be rough (e.g., as a result of being bead-blasted). In another embodiment, the layer 104 may be omitted (e.g., such that the surface 100a of the article 100 is the surface of the substrate 102).

Although the substrate 102 is describe herein by way of example to aluminum or an aluminum alloys, it will be appreciated that the processes described herein will generally work for metals and metal alloys. Other exemplary metals include stainless steel or titanium or their alloys.

To form the modified visual appearance, the beam 110a of laser pulses 11 may be directed onto the article 100 to remove the layer 104 and machine the substrate 102 therebeneath to form a recess 106 extending from the surface of the substrate 102 to a depth of 10 micron (μm) or more (e.g., 10's of μm) and terminating at a recessed surface 108. This process may herein be referred to as an “engraving process.”

In some embodiments, the engraving process parameters form recesses 300 that have a depth in a range from about 10 μm to about 100 μm. In some embodiments, the depth is in a range from about 10 μm to about 50 μm. In some embodiments, the depth is in a range from about 10 μm to about 25 μm.

In one embodiment, the recess 106 is formed by raster-scanning the beam 110a of laser pulses 11 multiple times across an area of the article 100 where the image is to be formed. Parameters of the beam 110a of laser pulses 11 are selected such that a layer of at least several microns is removed from the substrate 102 with each pass, resulting in a recessed surface 108 having a very smooth surface. In one embodiment, scans may be made at various angles and with various degrees of spot overlap to enhance the smoothness of the recessed surface 108.

The engraving process has laser engraving parameters with laser output that includes laser pulses 11 having laser spots at the surface of the substrate 102, wherein the laser spots 15a have a spot size that include a spot diameter in a range between about 20 μm and about 125 μm. In some embodiments, the spot diameter is in a range of between about 60 μm and about 110 μm. In some embodiments, the spot diameter is in a range of between about 75 μm and about 100 μm. For convenience, the term “spot diameter” is intended to include a major spatial axis of a laser spot that is not circular, such as an elliptical laser spot, as well as include the diameter of a circular laser spot.

In some embodiments, the laser engraving parameters include laser output having a laser wavelength between about 300 nanometer (nm) and about 2 μm. In some embodiments, the laser output has an infrared laser wavelength. In some embodiments, the laser output has a laser wavelength at about 1152 nm, 1090 nm, 1080 nm, 1064 nm, 1060 nm, 1053 nm, 1047 nm, 980 nm, 799 nm, or 753 nm. In some embodiments, the laser output has a laser wavelength between about 1150 nm and 1350 nm, 780 nm and 905 nm, or 700 nm and 1000 nm. In some embodiments, the laser output has a laser wavelength between about 700 nm and 1350 nm. In some embodiments, the laser output has a laser wavelength between about 980 nm and 1320 nm. In some embodiments, the laser output has a laser wavelength between about 980 nm and 1080 nm. In some embodiments, the laser output has a laser wavelength at about 1064 nm. In some embodiments, the laser output is provided by an infrared solid-state laser. In some embodiments, the laser output is provided by a diode-pumped infrared solid-state laser. In some embodiments, the laser output is provided by an infrared fiber laser.

In some embodiments, the laser engraving parameters have laser output that includes laser pulses 11 having pulse widths (pulse durations) in a range from about 500 femtoseconds (fs) to about 200 nanoseconds (ns). In some embodiments, the pulse widths have a range from about 1 ns to about 125 nanoseconds. In some embodiments, the pulse widths have a range from about 10 ns to about 100 ns.

In some embodiments, the laser engraving parameters include directing the laser pulses 11 onto the article at a pulse repetition rate that is greater than 50 kHz. In some embodiments, the pulse repetition rate is in a range from about 50 kHz to about 1000 kHz. In some embodiments, the pulse repetition rate is in a range from about 75 kHz to about 500 kHz. In some embodiments, the pulse repetition rate is in a range from about 100 kHz to about 200 kHz.

Generally, the laser engraving parameters include scanning multiple passes of laser output across the substrate 102. However, in some embodiments, a single pass of laser output across the substrate 102 may be sufficient to achieve a recessed surface 108 of a desired depth.

In one embodiment of the laser engraving process, the laser pulses 11 may have a spot diameter in a range between 20 μm and 125 μm, a wavelength between about 980 nm and 1320 nm, a pulse width in a range from 1 ns to 100 ns, and a pulse repetition rate in a range from 50 kHz to 500 kHz.

In another embodiment of the laser engraving process, the laser pulses 11 may have a spot diameter in a range between 50 μm and 100 μm, a wavelength between about 1047 nm and 1090 nm, a pulse width in a range from 10 ns to 100 ns, and a pulse repetition rate in a range from 100 kHz to 200 kHz.

The laser engraving process that forms the recessed surfaces 108 modifies the visual appearance of the substrate 102 so that is has an engraved visual appearance.

After forming the recessed surface 108, a beam 110b of laser pulses 11 may be directed onto the recessed surface 108 to transform it to a highly polished recessed surface. This process may herein be referred to as a “polishing process.” In some embodiments, laser polishing parameters include laser output having laser pulses 11 with a pulse energy in a range from about 100 μJ to about 2000 μJ. In some embodiments, the pulse energy is in a range from about 250 μJ to about 1500 μJ. In some embodiments, the pulse energy is in a range from about 500 μJ to about 1000 μJ.

In some embodiments, laser polishing parameters include directing the laser pulses 11 onto the recessed surface 108 at a pulse repetition rate that is greater than 50 kHz. In some embodiments, the pulse repetition rate is greater than 100 kHz. In some embodiments, the pulse repetition rate is in a range from about 50 kHz to about 10,000 kHz. In some embodiments, the pulse repetition rate is in a range from about 75 kHz to about 5,000 kHz. In some embodiments, the pulse repetition rate is in a range from about 100 kHz to about 2,000 kHz.

In some embodiments, the laser polishing parameters include laser output having a laser wavelength outside the infrared region. In some embodiments, the laser output has a visible laser wavelength. In some embodiments, the laser output has a laser wavelength between about 400 nm and about 700 nm. In some embodiments, the laser output has a laser wavelength at about 694 nm, 676 nm, 647 nm, 660-635 nm, 633 nm, 628 nm, 612 nm, 594 nm, 578 nm, 568 nm, 543 nm, 532 nm, 530 nm, 514 nm, 511 nm, 502 nm, 497 nm, 488 nm, 476 nm, 458 nm, 442 nm, 428 nm, or 416 nm. In some embodiments, the laser output has a laser wavelength between about 476 nm and about 569 nm. In some embodiments, the laser output has a green laser wavelength. In some embodiments, the laser output has a laser wavelength that is about 532 nm or about 511 nm. In some embodiments, the laser output is provided by a green solid-state laser. In some embodiments, the laser output is provided by a diode-pumped green solid-state laser. In some embodiments, the laser output is provided by a fiber laser.

In some embodiments, the laser polishing parameters include laser pulses 11 having laser spots 15b at the recessed surface 108 that have a spot diameter that is smaller than the spot diameter employed during the engraving process. In some embodiments of the laser polishing process, the spot diameter is in a range of between about 5 micron and about 50 μm. In some embodiments, the spot diameter is in a range of between about 15 μm and about 40 μm. In some embodiments, the spot diameter is in a range of between about 25 μm and about 35 μm. In some embodiments, the spot diameter is about 30 μm.

In some embodiments, the laser polishing parameters include scanning single pass of laser output across the recessed surface 108. In some embodiments, the laser polishing parameters include scanning (such as raster scanning) multiple passes of laser output across the recessed surface 108.

In some embodiments, the laser polishing parameters may include successively-directed laser pulses 11 that impinge upon the recessed surface 108 at laser spots 15b that overlap each other by between about 75% and 98%. In some embodiments, the successive laser spots 15b overlap by between about 85% and 95%. In some embodiments, the successive laser spots 15b overlap by between about 88% and 92%. In some embodiments, the successive laser spots 15b overlap by about 90%.

In one embodiment of the laser polishing process, the laser pulses 11 may have a spot diameter in a range between about 25 μm and about 35 μm, a green wavelength, an energy per pulse in a range from about 100 μJ to about 1000 μJ, a pulse repetition rate in a range from about 500 kHz to about 2,000 kHz, and a laser spot overlap between about 88% and 92%.

In another embodiment of the laser polishing process, the laser pulses 11 may have a spot diameter of about 30 μm, a wavelength of about 532 nm, an energy per pulse in a range from about 500 μJ to about 1000 μJ, a pulse repetition rate that is greater than 100 kHz, and a laser spot overlap of about 90%.

The polishing process modifies the visual appearance of the recessed surface 108 to impart a polished visual appearance to the recessed surface 108 that is different from engraved visual appearance of the recessed surface 108 and different from the preliminary visual appearance of the article 100, as presented at the surface 100a. In particular, the polished or smoothed surface may be substantially reflective and is intended to appear very bright to the human eye.

FIG. 2 schematically illustrates another embodiment of a process of forming an image in an article 100. With reference to FIG. 2, an article such as the article 100, having been subjected to the engraving and polishing processes discussed above, may be further machined using a beam 110c of laser pulses 11 to further modify the polished visual appearance of the polished recessed surface 108. This further-modified visual appearance may be different from the modified visual appearance discussed in FIG. 1. This process may herein be referred to as a “surface-modification process.”

For example, in some embodiments, laser pulses 11 directed onto and scanned across the polished recessed surface 108 may be configured to generate periodic structures, nanoparticles (e.g., containing the material forming the substrate 102), or the like or a combination thereof, which are structured to absorb light. This process may herein be referred to as a “darkening process.”

The laser pulses 11 directed onto the polished recessed surface 108 during the darkening process may have laser processing parameters that include a relatively short pulse duration, have a relatively small laser spot diameter, may be applied at relatively slow scanning speed, and may be applied at a relatively closely spaced pitch between successive scans.

In some embodiments, the laser darkening parameters include a pulse duration in a range from about 500 fs to about 100 ns. In some embodiments, the pulse duration is in a range from about 1 picosecond (ps) to about 50 ns. In some embodiments, the pulse duration is in a range from about 1 picosecond (ps) to about 25 ns. In some embodiments, the pulse duration is in a range from about 1 ps to about 10 ns.

In some embodiments, the laser darkening parameters include a spot diameter of a laser spot 15c that is smaller than the spot diameter employed during the engraving process or smaller than the spot diameter employed during the polishing process. In some embodiments of the laser polishing process, the spot diameter is in a range of between about 1 micron and about 50 μm. In some embodiments, the spot diameter is smaller than about 30 μm. In some embodiments, the spot diameter is in a range of between 1 μm and 30 μm. In some embodiments, the spot diameter is in a range of between about 1 μm and about 20 μm. In some embodiments, the spot diameter is in a range of between about 1 μm and about 10 μm.

In some embodiments, the darkening process parameters include directing the laser pulses 11 onto the article at a pulse repetition rate that is greater than 10 kHz. In some embodiments, the pulse repetition rate is in a range from about 10 kHz to about 1000 kHz. In some embodiments, the pulse repetition rate is in a range from about 100 kHz to about 500 kHz. In some embodiments, the pulse repetition rate is in a range from about 100 kHz to about 300 kHz. In some embodiments, the pulse repetition rate is about 100 kHz.

In some embodiments, the darkening process parameters include laser pulses 11 that exhibit power in a range from about 0.5 W to about 50 W. In some embodiments, the power is in a range from about 1 W to about 10 W. In some embodiments, the power is in a range from about 2 W to about 8 W. In some embodiments, the power is about 5 W.

In some embodiments, the laser darkening parameters include the application of the laser pulses 11 at a scan speed that is in a range of between about 1 mm/sec and about 5000 mm/sec. In some embodiments, the scan speed is in a range of between about 5 mm/sec and about 500 mm/sec. In some embodiments, the scan speed is in a range of between about 10 mm/sec and about 50 mm/sec. In some embodiments, the scan speed is in a range of between about 12 mm/sec and about 40 mm/sec. In some embodiments, the scan speed is in a range of between about 15 mm/sec and about 35 mm/sec. In some embodiments, the scan speed is about 25 mm/sec.

In some embodiments, the laser darkening parameters include the application of laser pulses 11 at a pitch (between successive scans) is in a range of between about 0.5 μm and about 50 μm. In some embodiments, the pitch between successive scans is in a range of between about 1 μm and about 30 μm. In some embodiments, the pitch between successive scans is in a range of between about 5 μm and about 15 μm. In some embodiments, the pitch between successive scans is about 10 μm.

In one embodiment, the laser darkening parameters include a pulse duration is in a range from about 1 ps to about 10 ns, spot diameter is less than about 30 μm, a scan speed is in a range of between about 1 mm/sec and about 50 mm/sec, and a pitch between successive scans is in a range of between about 1 μm and about 30 μm.

In one embodiment, the laser darkening parameters include a pulse duration is in a range from about 1 ps to about 10 ns, spot diameter is in a range of between about 1 μm and about 30 μm, a scan speed is in a range of between about 15 mm/sec and about 35 mm/sec, and a pitch between successive scans is in a range of between about 5 μM and about 15 μm.

In one embodiment, the laser darkening parameters include a pulse duration is in a range from about 1 ps to about 10 ns, spot diameter in a range of between about 1 μM and about 30 μm, a scan speed is about 25 mm/sec, and a pitch between successive scans is about 10 μm.

Thus, upon subjecting the polished recessed surface 108 to the darkening process, a further-modified visual appearance is imparted to the recessed surface 108, which is different from the preliminary visual appearance of the article 100, as presented at the surface 100a, is different from the engraved visual appearance, and different from the polished visual appearance of the polished recessed surface 108. In particular, the darkening process is intended to absorb light and make the recessed surface 108 appear black to the human eye.

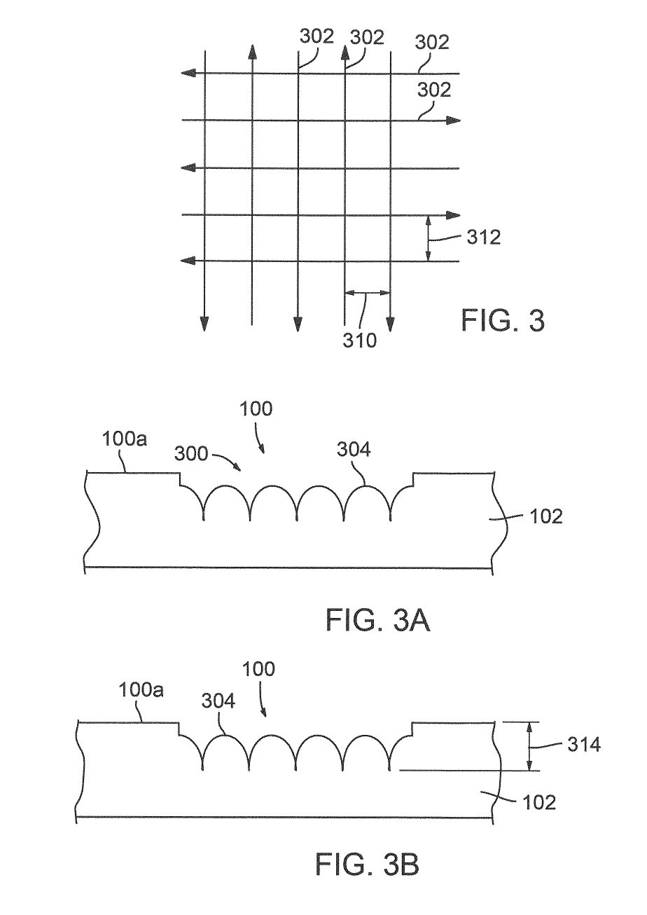

FIG. 3 schematically illustrates yet another embodiment of a process of forming an image in an article 100. FIGS. 3A and 3B are front and side elevation views of an image in an article formed by the process represented by FIG. 3. With reference to FIGS. 3, 3A, and 3B, an article 100 having a surface 100a with a preliminary visual appearance may be machined using a beam of laser pulses 11 to form a character or image having a modified visual appearance that is different from the preliminary visual appearance. In the illustrated embodiment, the article 100 may be provided by subjecting the substrate 102 to the engraving and polishing processes discussed above with respect to FIGS. 1 and 2, or may be provided differently.

For example in some embodiments, a beam of laser pulses 11 may be directed onto the article 100 to melt, remove or otherwise shape or machine the substrate 102, the layer 104, or the substrate 102 and the layer 104, to form a network of recesses 300 intersecting one another and extending from the surface of the article 100 to a depth 314 of several microns. This surface modification process may herein be referred to as a “cross-hatching process.”

In some embodiments, the recesses 300 are formed by scanning the beam of laser pulses 11 multiple times across an area of the article 100 where the image is to be formed (e.g., in the various directions indicated by the arrows 302). This image may be formed within the recessed surface 108 or within the surface 100a of the article 100 or the substrate 102. In some embodiments, the scan directions represented by the arrows 302 may extend along parallel lines. In some embodiments, the scan directions represented by the arrows 302 may extend along parallel lines that are parallel to an edge of the article 100. In some embodiments, the scan directions may extend along curved parallel lines (not shown). In some embodiments, the scan directions may extend along transverse directions that are not orthogonal (not shown). In some embodiments, the scan directions represented by the arrows 302 may extend along mutually-orthogonal directions.

In some embodiments, the cross-hatching process parameters include a center-to-center distance 310 or 312 between adjacent recesses 300 in a range from about 1 μm to about 50 μm. In some embodiments, the center-to-center distance between adjacent recesses 300 is in a range from about 5 μm to about 30 μm. In some embodiments, the center-to-center distance between adjacent recesses 300 is in a range from 10 μm to 20 μm. The spacing or pitch 310 or 312 between scans may be the same as or different from the center-to-center distance between adjacent recesses 300. Moreover, the center-to-center distance between adjacent recesses 300 may be different in the transverse directions, and the spacing or pitch 310 or 312 between scans may be different in transverse directions.

In some embodiments, the cross-hatching process parameters include laser output having a laser wavelength outside the infrared region. In some embodiments, the laser output has a visible laser wavelength. In some embodiments, the laser output has a laser wavelength between about 400 nm and about 700 nm. In some embodiments, the laser output has a laser wavelength at about 694 nm, 676 nm, 647 nm, 660-635 nm, 633 nm, 628 nm, 612 nm, 594 nm, 578 nm, 568 nm, 543 nm, 532 nm, 530 nm, 514 nm, 511 nm, 502 nm, 497 nm, 488 nm, 476 nm, 458 nm, 442 nm, 428 nm, or 416 nm. In some embodiments, the laser output has a laser wavelength between about 476 nm and about 569 nm. In some embodiments, the laser output has a green laser wavelength. In some embodiments, the laser output has a laser wavelength that is about 532 nm or about 511 nm. In some embodiments, the laser output is provided by a green solid-state laser. In some embodiments, the laser output is provided by a diode-pumped green solid-state laser. In some embodiments, the laser output is provided by a fiber laser.

In some embodiments, the cross-hatching process parameters include laser output having laser spots with a spot size that includes a spot diameter in a range between about 25 μm and about 200 μm. In some embodiments, the spot diameter is in a range of between about 40 μm and about 125 μm. In some embodiments, the spot diameter is in a range of between about 50 μm and about 100 μm.

In some embodiments, the cross-hatching process parameters form recesses 300 that have a depth in a range from about 1 μm to about 10 μm. In some embodiments, the depth is in a range from about 1 μm to about 5 μm. In some embodiments, the depth is in a range from about 1 μm to about 3 μm.

In some embodiments, the laser cross-hatching process parameters include the application of the laser pulses 11 at a scan speed that is in a range of between about 25 mm/sec and about 150 mm/sec. In some embodiments, the scan speed is in a range of between about 50 mm/sec and about 100 mm/sec. In some embodiments, the scan speed is in a range of between about 60 mm/sec and about 80 mm/sec. In some embodiments, the scan speed is about 75 mm/sec.

In some embodiments, the laser cross-hatching process parameters include laser pulses 11 that exhibit power in a range from about 1 W to about 10 W. In some embodiments, the power is in a range from about 2 W to about 8 W. In some embodiments, the power is in a range from about 3 W to about 6 W. In some embodiments, the power is about 4 W.

In one embodiment, the laser cross-hatching process parameters include laser output with a visible laser wavelength, a spot diameter is in a range of between about 40 μm and about 125 μm, a scan speed is in a range of between about 50 mm/sec and about 100 mm/sec, a power in a range from about 2 W to about 8 W, center-to-center distance between adjacent recesses 300 is in a range from about 5 μm to about 30 μm, and a pitch 310 or 312 between scans in a range from about 5 μm to about 30 μm.

In one embodiment, the laser cross-hatching process parameters include laser output with a green laser wavelength, a spot diameter is in a range of between about 50 μm and about 100 μm, a scan speed is in a range of between about 60 mm/sec and about 80 mm/sec, a power in a range from about 3 W to about 6 W, center-to-center distance between adjacent recesses 300 is in a range from about 10 μm to about 20 μm, and a pitch 310 or 312 between scans in a range from about 10 μm to about 20 μm.

In one embodiment, the laser cross-hatching process parameters include laser output with a green laser wavelength, a spot diameter is in a range of between about 50 μm and about 100 μm, a scan speed is in a range of about 75 mm/sec, a power in a range from about 4 W, center-to-center distance between adjacent recesses 300 is in a range from about 10 μm to about 20 μm, and a pitch 310 or 312 between scans in a range from about 10 μm to about 20 μm.

In some embodiments of the cross-hatching process, the laser pulses 11 are directed onto the article 100 such that they are out-of-focus upon impinging the article 100. Because the beam of laser pulses 11 is out of focus, the spot size is very large and lines etched in the material of the article 100 will overlap. This causes the top surface of the pattern of humps or bumps 304 to be below the surface 100a of the article 100.

Upon performing the cross-hatching process exemplarily described above, a pattern of reflective bumps 304 is formed within the article 100. The bumps 304 have a smooth surface (e.g., are formed, at least in part, of material of the substrate 102 that has been melted by the beam of laser pulses 11 and then re-solidified), are stable, resist wear and the pattern of bumps 304 produces an image having a high brightness. While not wishing to be bound by any particular theory, it is believed that light incident on the pattern of bumps 304 is reflected and scattered by the bumps 304 so that light reflected from the pattern of bumps 304 appears white to the human eye. The pattern of reflective bumps 304 provides a brighter white appearance than that of the original surface 100a, that of the substrate surface 102, that of the unpolished recessed surface 108, and that of the polished recessed surface 108. Moreover, the pattern of bumps 304 provides a brighter white than that achievable by conventional etching processes. It is also noted than when the cross-hatching process is perform without a preceding polishing process, the pattern of bumps 304 provides a white matte appearance that is less glossy then when performed after a polishing process, but the matte white is still a brighter white than that achievable by conventional etching processes.

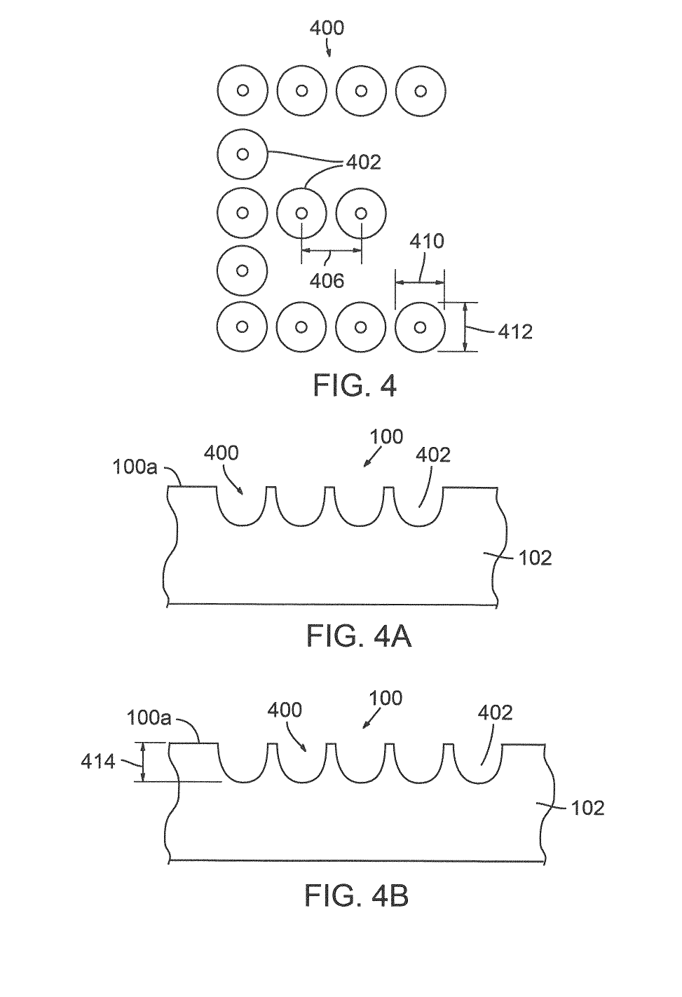

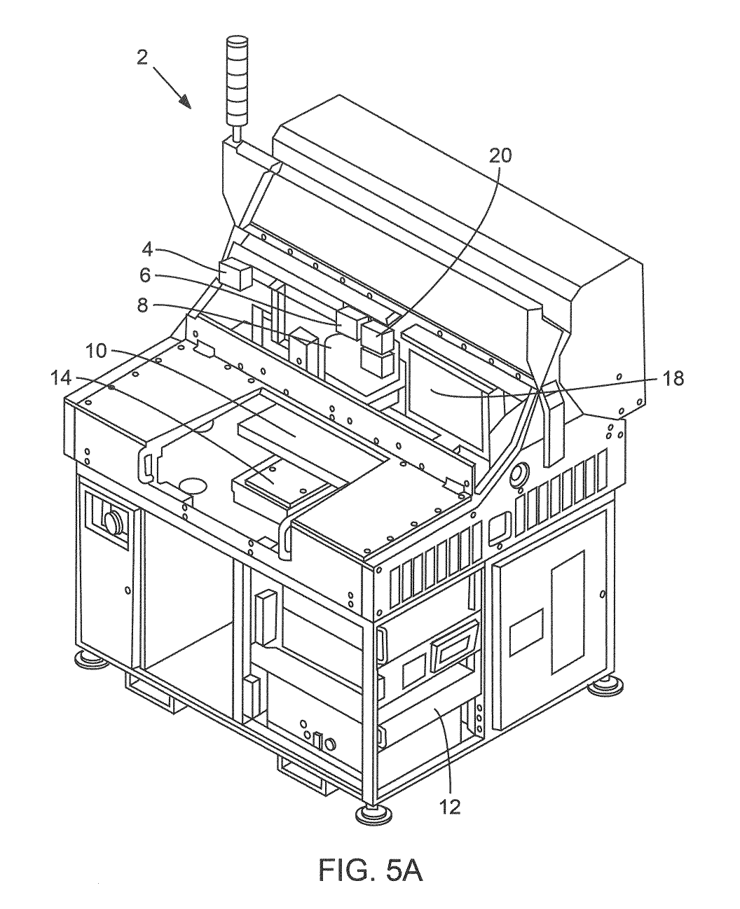

FIG. 4 schematically illustrates still another embodiment of a process of forming an image in an article 100. FIGS. 4A and 4B are front and side elevation views of an image in an article formed by the process represented by FIG. 4. With reference to FIGS. 4, 4A, and 4B, an article 100 having a surface 100a with a preliminary visual appearance may be machined using a beam of laser pulses 11 to form a character or image having a modified visual appearance that is different from the preliminary visual appearance. In the illustrated embodiment, the article 100 may be provided by subjecting the substrate 102 to the engraving and polishing processes discussed above with respect to FIGS. 1 and 2, or may be provided differently.

To form the modified visual appearance, a beam of laser pulses 11 may be directed onto the article 100 to melt, remove or otherwise shape or machine the substrate 102, the layer 104, or the substrate 102 and the layer 104, to form a pattern 400 of non-overlapping recesses 402 extending from the surface 100a of the article 100 to a depth beneath the surface to the substrate 102 or beneath the recessed surface 108. This surface modification process may herein be referred to as a “punch-patterning process.”

In some embodiments of the punch-patterning process, the recesses 402 have a depth 414 in a range from about 1 μm to about 50 μm. In some embodiments, the depth 414 is in a range from about 1 μm to about 25 μm. In some embodiments, the depth 414 is in a range from about 5 μm to about 15 μm.

In some embodiments, punch-patterning process parameters include a center-to-center distance 406 between adjacent recesses 402 in a range from about 10 μm to about 100 μm. In some embodiments, the center-to-center distance 406 between adjacent recesses 402 is in a range from about 20 μm to about 75 μm. In some embodiments, the center-to-center distance 406 between adjacent recesses 402 is in a range from about 30 μm to about 60 μm. In some embodiments, the center-to-center distance 406 between adjacent recesses 402 is about 40 μm.

In some embodiments, punch-patterning process parameters include formation of each recess 402 with about 10 to 100 laser pulses 11 onto the article 100 where the image is to be formed (e.g., along the various scan paths indicated by the arrows 302 in FIG. 3). In some embodiments, each recess 400 is formed by about 20 to 80 laser pulses 11. In some embodiments, each recess 400 is formed by about 30 to 70 laser pulses 11. In some embodiments, each recess 400 is formed by about 40 to 60 laser pulses 11.

In some embodiments, punch-patterning process parameters include laser output having an infrared laser wavelength. In some embodiments, the laser output has a laser wavelength between about 700 nm and about 20 μm. In some embodiments, the laser output has a laser wavelength at about 1152 nm, 1090 nm, 1080 nm, 1064 nm, 1060 nm, 1053 nm, 1047 nm, 980 nm, 799 nm, or 753 nm. In some embodiments, the laser output has a laser wavelength between about 1150 nm and 1350 nm, 780 nm and 905 nm, or 700 nm and 1000 nm. In some embodiments, the laser output has a laser wavelength between about 700 nm and 1350 nm. In some embodiments, the laser output has a laser wavelength between about 980 nm and 1320 nm. In some embodiments, the laser output has a laser wavelength between about 980 nm and 1080 nm. In some embodiments, the laser output has a laser wavelength at about 1064 nm. In some embodiments, the laser output is provided by an infrared solid-state laser. In some embodiments, the laser output is provided by a diode-pumped infrared solid-state laser. In some embodiments, the laser output is provided by an infrared fiber laser.

In some embodiments, the laser output has a laser wavelength between about 9.4 μm and about 10.6 μm. In some embodiments, the laser output is provided by a CO₂ laser.

In some embodiments, the punch-patterning process parameters include laser pulses 11 having laser spots at the recessed surface 108 that have a spot diameter that is smaller than the spot diameter employed during the engraving process. In some embodiments of the laser polishing process, the spot diameter is in a range of between about 5 micron and about 50 μm. In some embodiments, the spot diameter is in a range of between about 15 μm and about 40 μm. In some embodiments, the spot diameter is in a range of between about 25 μm and about 35 μm. In some embodiments, the spot diameter is about 30 μm. The major spatial axis 410 or 412 may have a distance that is about equal to or slightly larger or slightly smaller than the spot diameter.

In some embodiments, the punch-patterning process parameters include directing the laser pulses 11 onto the article at a pulse repetition rate that is greater than 10 kHz. In some embodiments, the pulse repetition rate is in a range from about 10 kHz to about 1000 kHz. In some embodiments, the pulse repetition rate is in a range from about 50 kHz to about 500 kHz. In some embodiments, the pulse repetition rate is in a range from about 75 kHz to about 200 kHz. In some embodiments, the pulse repetition rate is about 100 kHz.

In some embodiments, the punch-patterning process parameters include laser pulses 11 that exhibit power in a range from about 1 W to about 10 W. In some embodiments, the power is in a range from about 2 W to about 8 W. In some embodiments, the power is in a range from about 4 W to about 6 W. In some embodiments, the power is about 5 W.

In one embodiment, the punch-patterning process includes recesses 402 having a depth 414 in a range from about 5 μm to about 15 μm, a center-to-center distance 406 between adjacent recesses 402 in a range from about 30 μm to about 60 μm, formation of each recess 402 by about 30 to 70 laser pulses 11, laser pulses 11 having an infrared wavelength, a spot diameter in a range of between about 15 μm and about 40 μm, a pulse repetition rate in a range from about 50 kHz to about 500 kHz, and laser pulse power in a range from about 1 W to about 10 W.

In one embodiment, the punch-patterning process creates recesses 402 having a depth in a range from about 5 μm to about 15 μm, a center-to-center distance between adjacent recesses 402 of about 40 μm, formation of each recess 402 by about 40 to 60 laser pulses 11 having an infrared wavelength from a fiber laser, a spot diameter of about 30 μm, a pulse repetition rate of about 100 kHz, and laser pulse power of about 5 W.

Upon performing the punch-patterning process exemplarily described above, a pattern 400 of recesses 402 having a bowl-shaped taper can be formed within the article 100. The recesses 402 have a smooth surface (e.g., are formed, at least in part, of material of the substrate 102 that has been melted by the beam of laser pulses 11 and then re-solidified), are stable, resist wear and the pattern 400 of recesses 402 produces an image having a high brightness. While not wishing to be bound by any particular theory, it is believed that light incident on the pattern 400 of recesses 402 is reflected and scattered by the recesses so that light reflected from the pattern 400 of recesses 402 appears white to the human eye. The pattern 400 of recesses 402 provides a brighter white appearance than that of the original surface 100a, that of the substrate surface 102, that of the unpolished recessed surface 108, and that of the polished recessed surface 108. Moreover, the pattern 400 of recesses 402 provides a brighter white than that achievable by conventional etching processes. It is also noted than when the punch-patterning process is perform without a preceding polishing process the pattern 400 of recesses 402 provides a white matte appearance that is less glossy then when performed after a polishing process, but the matte white is still a brighter white than that achievable by conventional etching processes.

As noted previously, exemplary laser processing parameters which may be selected to improve the reliability and repeatability of laser processing (marking) of substrates include laser type, wavelength, pulse duration, pulse energy, pulse temporal shape, pulse spatial shape, focal spot size (beam waist), pulse repetition rate, number of pulses, bite size, laser spot overlap, scan speed, and number of scan passes per impingement location. Additional laser pulse parameters include specifying the location of the focal spot relative to the surface of the article 100 and directing the relative motion of the laser pulses 11 with respect to the article 100.

An exemplary laser processing system that can be adapted to engrave, polish, and modify surfaces of the articles 100 may include multiple tools, such as independently directed laser heads, to perform one or more of the engraving, polishing, and additional modifying processes. U.S. Pat. No. 5,847,960 of Cutler describes a multi-tool micromachining system and is herein incorporated by reference. Alternatively, an exemplary laser of the laser processing system can be configured to engrave, polish, and modify surfaces of the articles 100 with different sets of laser processing parameters to achieve the different engraving, polishing, and additional modifying processes. Alternatively, one laser processing system may be employed to perform two of the engraving, polishing, and additional modifying processes, and another laser processing system may be employed to perform the other of the engraving, polishing, and additional modifying processes. Alternatively, each of the engraving, polishing, and additional modifying processes may be performed on distinct laser processing systems.

Laser processing parameters that may be advantageously employed by some embodiments include using lasers with wavelengths which range from IR through UV, or more particularly from about 10.6 microns down to about 266 nm. One or more of lasers 38 may operate in a range of 1 W to 100 W, or some may operate in a range of 1 W to 12 W. Pulse duration may be in range from 1 ps to 1000 ns, or the pulse duration may be in a range from 1 ps to 200 ns in some embodiments. The laser repetition rate may be in the range from 1 kHz to 100 MHz, or the laser repetition rate may be in a range from 10 KHz to 1 MHz in some embodiments. Laser fluence may range from about 0.1×10⁻⁶ J/cm² to 100.0 J/cm², or the laser fluence may range from 1.0×10⁻² J/cm² to 10.0 J/cm² in some embodiments. The speed with which the laser beam moves with respect to the article 100 being marked may range from 1 mm/s to 10 m/s, or the scan speed may range from 100 mm/s to 1 m/s for some embodiments. The pitch or spacing between adjacent rows of laser pulses 11 on the surface of the article 100 may range from 1 micron to 1000 microns, or the pitch or spacing may range from 10 microns to 100 microns for some embodiments. The size of the laser spot 15 of the laser pulses 11 measured at the surface of the article 100 may range from 1 microns to 1000 microns, or the laser spot may range from 25 microns to 500 microns for some embodiments. The location (elevation) of the focal spot of the laser pulses 11 with respect to the surface of the article 100 may range from −10 mm to +10 mm, or the elevation of the focal spot may range from 0 to +5 mm with respect to the surface.

An exemplary laser processing system which can be adapted to process the articles 100 is the ESI MM5330 micromachining system 2, manufactured by Electro Scientific Industries, Inc., Portland, Oreg. 97229. Such a micromachining system 2 that may employ a diode-pumped Q-switched solid-state laser 38 with an average power of 5.7 W at 30 K Hz pulse repetition rate, and may be configured for some embodiments to emit the second harmonic wavelength at 532 nm or other wavelengths. Another exemplary laser processing system that may be adapted to process the articles 100 is the ESI ML5900 micromachining system, also manufactured by Electro Scientific Industries, Inc., Portland, Oreg. 97229. Such a laser micromachining system 2 may employ a solid-state diode-pumped laser 38 that can be configured to emit wavelengths from about 266 nm (UV) to about 1064 nm (IR) at pulse repetition rates up to 5 MHz. For example, the laser 38 may be optionally frequency doubled using a solid-state harmonic frequency generator to reduce the wavelength to 532 nm or tripled to about 355 nm, thereby creating visible (green) or ultraviolet (UV) laser pulses, respectively.

Other exemplary laser micromachining systems include models 5335, 5950, and 5970, which are also manufactured by Electro Scientific Industries, Inc., Portland, Oreg. 97229.

In some embodiments, the laser 38 may be a diode pumped Nd:YVO₄ solid-state laser operating at 1064 nm wavelength, model Rapid manufactured by Lumera Laser GmbH, Kaiserslautern, Germany. The laser 38 can be configured to yield up to 6 W of continuous power at a 1-2 MHz pulse repetition rate. In some embodiments, the laser 38 may be a diode pumped Nd:YVO₄ solid-state laser operating at a frequency tripled 355 nm wavelength, model Vanguard manufactured by Spectra-Physics, Santa Clara, Calif. 95054. The laser 38 can be configured to yield up to 2.5 W, but is generally run at an 80 MHz mode-locked pulse repetition rate which yields a power of about 1 W.

The laser micromachining systems 2 may be adapted by the addition of appropriate laser(s) 38, laser optics 6 and 8, parts handling equipment, and control software to reliably and repeatably process the surfaces according to the methods disclosed herein. These modifications permit the laser processing system to direct laser pulses 11 with the appropriate laser processing parameters to the desired places on an appropriately positioned and held article 100 at the desired rate and pitch to create the desired surface effect with desired color and optical density.

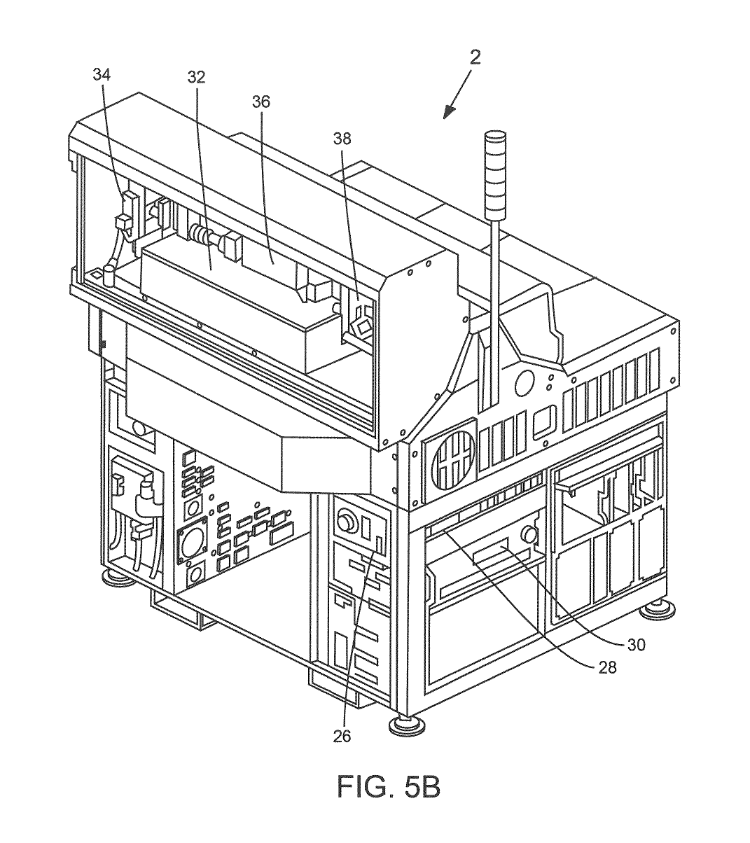

FIGS. 5A and 5B are diagrams of the ESI Model MM5330 laser micromachining system 2 adapted for processing articles 100, and FIG. 6. is a schematic diagram emphasizing certain components of the laser micromachining system 2 of FIGS. 5A and 5B. With reference to FIGS. 5A, 5B, and 6, adaptations to the ESI Model MM5330 laser micromachining system 2 include a laser mirror and a power attenuator 4, laser beam steering optics 6 (such as a pair of galvanometer-controlled mirrors) and laser field optics 8 adapted to handle the laser wavelength, power, and beam sizes of some embodiments, a chuck 10 adapted to fixture articles 100, stage(s) 14, 18, and 20 adapted to the move the article 100 and the position of the laser pulses 11 relative to each other, and a controller 12 adapted to store laser processing and/or beam position targeting data and to cause the laser 38 to emit the laser pulses 11 and direct them specific locations on the article 100.

FIG. 5B shows another view of an adapted ESI Model MM5330 laser micromachining system 2, including a laser interlock controller 26 that controls the operation of the interlock sensors (not shown) which prevent operation of the laser 38 when various panels of the MM5330 laser micromachining system 2 are opened, the controller 28, a laser power supply 30, a laser beam collimator 32, laser beam optics 34 and laser mirror 36, all of which have been adapted to work with the adapted laser 38.

The laser 38 or an alternative laser can be configured to produce laser pulses 11 with duration of 1 ps to 1,000 ns in cooperation with the controller 28 and laser power supply 30. These laser pulses 11 may be Gaussian or specially shaped by the laser beam optics 34 to achieve desired surface effects. The laser beam optics 34, in cooperation with the controller 28, laser beam steering optics 6, and laser field optics 8 cooperate to direct the laser pulses 11 to form a laser spot 15 on an article 100 fixtured by the chuck 10. In some embodiments, the beam steering optics 6 may include one or more galvanometers, a fast steering mirrors, an acousto-optic deflectors, electro-optic deflectors, or any combination thereof. Motion control elements Y stage 14, X stage 18, Z stage (optics stage) 20, and laser beam steering optics 6 combine to provide compound beam positioning capability, one aspect of which is the ability to position the laser beam with respect to the article 100 while the article 100 is in continuous motion with respect to the to the laser spot 15 of the laser beam. This capability is described in U.S. Pat. No. 5,751,585 of Cutler et al., which is assigned to the assignee of this application and which is incorporated herein by reference. Compound beam positioning includes the ability to create surface effects in specific shapes on an article 100 while the article 100 is in relative motion to the laser beam by having the controller 28 direct some portion of the motion control elements, namely the Y stage 14, the X stage 18, the Z stage 20, and the laser beam steering optics 6 to compensate for continuous relative motion induced by other portions of the motion control elements.

The laser pulses 11 are also shaped by the laser beam optics 34 in cooperation with the controller 28. The laser beam optics 34 can determine the spatial geometric shape as well as the spatial energy profile of the laser pulses 11, which may be Gaussian or specially profiled. For example, a “top hat” spatial profile may be used to deliver a laser pulse 11 having an even distribution of fluence over the entire area of a laser spot 15 that impinges the article 100 being marked. Specially shaped spatial profiles such as this may be created using diffractive optical elements or other optical beam-shaping elements. With a Gaussian profile, assuming that the ablation threshold is exceeded at some point on the profile, the focal spot area within the ablation threshold area may exceed the ablation threshold possibly causing damage while the area of the focal spot outside the ablation threshold will not remove material. Use of diffractive optical elements in micromachining is disclosed in U.S. Pat. No. 6,433,301 of Dunsky et al. which is assigned to the assignee of this application and incorporated herein by reference.

The laser spot size refers to the size of the focal spot of the laser beam. The actual spot size of the laser spot 15 on the surface of the article 100 being marked may be different due to the focal spot being positioned above or beneath the surface. In addition, the laser beam optics 34, the laser beam steering optics 6, the laser field optics 8, and the Z stage 20 cooperate to control the depth of focus of the laser spot 15, or how quickly the laser spot 15 goes out of focus as the point of intersection on the article 100 moves away from the focal plane. By controlling the depth of focus, the controller 28 can direct the laser beam optics 34, laser beam steering optics 6, laser field optics 8, and the Z stage 20 to position the laser spot either at or near the surface of the specimen repeatably with high precision. Making marks by positioning the focal spot above or below the surface of the article 100 allows the laser beam to defocus by a specified amount and thereby increase the area illuminated by the laser pulse 11 and decrease the laser fluence at the surface. Since the geometry of the beam waist is known, precisely positioning the focal spot above or below the actual surface of the article 100 will provide additional precision control over the spot size and fluence. Altering the laser fluence by altering the laser spot geometry by positioning the focal spot combined with the use of picosecond lasers, which produce laser pulse widths in the range from 1 to 1,000 ps, is a way to reliably and repeatably create some of the surface effects on the article 100 as noted above. The fluence may also be altered by an AOM fluence attenuator or other optical attenuation devices positioned along the beam path 44.

FIG. 7 shows a diagram of a laser pulse focal spot 40 and the beam waist in its vicinity. The beam waist is represented by a surface 42 which is the diameter (or major spatial axis) of the spatial energy distribution of a laser pulse 11 as measured by the FWHM method on the optical axis 44 along which the laser pulses 11 travel. The diameter 48 represents the laser spot size of the laser spot 15 on the surface of the substrate 102 when the laser processing system focuses the laser pulse 11 at a distance (A-O) above the surface 102. The diameter 46 represents the laser spot size of the laser spot 15 on the surface of the substrate 102 when the laser processing system focuses the laser pulses 11 at a distance (O-B) below the surface.

It will be appreciated that other or additional lasers or different micromachining systems can be employed and that different engraving, polishing, and surface modification techniques can be employed to provide desirable optical surface characteristics. Some alternative micromachining systems, lasers, and process parameters can be found in U.S. Pat. Nos. 8,379,679, 8,389,895, and 8,604,380, which are herein incorporated by reference.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

1. A method for processing a substrate with different sets of laser processing parameters to achieve different surface effects in the substrate, the material having an outer surface with a first surface characteristic, the method comprising:
employing a first set of laser processing parameters with first parameter values operable to form a recess in the substrate to a depth beneath the outer surface, wherein the recess in the substrate has a recessed surface with a second surface characteristic;
employing a second set of laser processing parameters with second parameter values operable to alter the recessed surface to have a third surface characteristic that is different from the second surface characteristic, wherein at least one of the second parameter values is different from a corresponding one of the first parameter values; and
employing a third set of laser processing parameters with third parameter values operable to alter the recessed surface to have a fourth surface characteristic that is different from the second surface characteristic and the third surface characteristic, wherein at least one of the third parameter values is different from a corresponding one of the first parameter values, and wherein at least the one of third parameter values or another of the third parameter values is different from a corresponding one of the second parameter values.

2. The method of claim 1, wherein the first set of laser processing parameters are suitable for performing an engraving process, and wherein the second set of laser processing parameters are suitable for performing a polishing process to polish portions of the recessed surface.

3. The method of claim 1, wherein the third set of laser processing parameters are suitable for performing an a darkening process to darken portions of the recessed surface.

4. The method of claim 1, wherein the third set of laser processing parameters are suitable for performing a cross-hatching process to cross-hatch portions of the recessed surface.

5. The method of claim 1, wherein the third set of laser processing parameters are suitable for performing a punching process to punch depressions in the recessed surface.

6. The method of claim 1, wherein the first and second set of laser processing parameters have different ones of wavelength values or spot size values.

7. The method of claim 1, wherein the first and third set of laser processing parameters have different ones of pulse width values or spot size values.

8. The method of claim 1, wherein the first and third set of laser processing parameters have different ones of repetition rate values or spot size values.

9. The method of claim 1, wherein the second and third set of laser processing parameters have different ones of scan speed values or spot size values.

10. The method of claim 1, wherein the first parameter values include at least two of a spot size having a major spatial axis of between about 25 μm and about 100 μm, an infrared wavelength, a pulse width of between about 10 ns and about 100 ns, and a pulse repetition rate of between about 100 kHz and about 200 kHz.

11. The method of claim 1, wherein the second parameter values include at least two of a spot size having a major spatial axis of between about 10 μm and about 50 μm, a visible wavelength, a pulse width of between about 10 ns and about 100 ns, a pulse repetition rate greater than about 100 kHz, and a pulse energy between about 500 μJ to about 1000 μJ.

12. The method of claim 1, wherein the third parameter values include at least two of spot size having a major spatial axis of between shorter than about 50 μm, a pulse width of between about 500 fs and about 50 ps, and a scan speed of slower than about 50 mm/second.

13. The method of claim 1, wherein the third parameter values include at least two of a spot size having a major spatial axis of between about 50 μm and about 100 μm, a wavelength shorter than 1000 nm, an average power between about 1 to 5 watts, and a scan speed of faster than about 70 mm/second.

14. The method of claim 1, wherein the third parameter values include at least two of, a wavelength in the infrared, an average power of between about 3 to 10 watts, and a pulse repetition rate of between about 75 kHz and about 125 kHz.

15. The method of claim 1, wherein laser pulses of the second set form laser spots on the recessed surface and are directed so that a sequential laser spot overlaps a preceding laser spot by 75% to 95%.

16. The method of claim 1, wherein laser pulses of the second set produces a reflective or polished surface.

17. The method of claim 1, wherein laser pulses of the third set generate periodic structures in the recessed surface that are structured to absorb light.

18. The method of claim 1, wherein laser pulses of the third set form a pattern of nonoverlapping craters in the recessed surface.

19. A method for processing a substrate with different sets of laser processing parameters to achieve different surface effects in the substrate, the material having an outer surface with a first surface characteristic, the method comprising:
employing a first set of laser processing parameters with first parameter values operable to engrave the substrate by forming a recess in the substrate to a depth beneath the outer surface, wherein the recess in the substrate has a recessed surface with a second surface characteristic;
employing a second set of laser processing parameters with second parameter values operable to polish the recessed surface to have a third surface characteristic that is different from the second surface characteristic, wherein at least one of the second parameter values is different from a corresponding one of the first parameter values; and
employing a third set of laser processing parameters with third parameter values operable to modify the recessed surface to have a fourth surface characteristic that is different from the second surface characteristic and the third surface characteristic, wherein at least one of the third parameter values is different from a corresponding one of the first parameter values, and wherein at least the one of third parameter values or another of the third parameter values is different from a corresponding one of the second parameter values.

20. A laser system for processing a substrate with different sets of laser processing parameters to achieve different surface effects in the substrate, the material having an outer surface with a first surface characteristic, the method comprising:
a first laser configured to provide a first set of laser processing parameters with first parameter values operable to form a recess in the substrate to a depth beneath the outer surface, wherein the recess in the substrate has a recessed surface with a second surface characteristic;
a second laser configured to provide a second set of laser processing parameters with second parameter values operable to alter the recessed surface to have a third surface characteristic that is different from the second surface characteristic, wherein at least one of the second parameter values is different from a corresponding one of the first parameter values, wherein the second laser is the first laser or a different laser; and
a third laser configured to provide a third set of laser processing parameters with third parameter values operable to alter the recessed surface to have a fourth surface characteristic that is different from the second surface characteristic and the third surface characteristic, wherein at least one of the third parameter values is different from a corresponding one of the first parameter values, and wherein at least the one of third parameter values or another of the third parameter values is different from a corresponding one of the second parameter values, wherein the third laser is the first or second laser or a different laser.

21. A method of modifying the appearance of an aluminum surface, comprising:
forming a recess in an aluminum surface to provide a recessed aluminum surface exhibiting a first light absorption level; and
modifying the recessed aluminum surface by application of laser output to process regions of the recessed aluminum surface at a scan speed in a range of between about 15 mm/sec and about 35 mm/sec and at a pitch between successive scans in a range of between about 5 μm and about 15 μm, wherein the laser output includes laser pulses having a pulse duration in a range from about 1 ps to about 10 ns a laser spot diameter in a range of between about 1 μm and about 30 μm, and wherein application of the laser output causes processed regions of the recessed aluminum surface to exhibit a second light absorption level that is greater than the first light absorption level, thereby causing the processed regions of the recessed aluminum surface to appear black to a human eye viewing the processed regions of the recessed aluminum surface.

22. A method of modifying the appearance of an aluminum surface, comprising:
forming a recess in an aluminum surface to provide a recessed aluminum surface exhibiting a first surface appearance; and
modifying the recessed aluminum surface by application of laser output to process regions of the recessed aluminum surface at a scan speed in a range of between about 60 mm/sec and about 80 mm/sec and at a pitch between successive scans in a range of between about 10 μm and about 20 μm, wherein the laser output includes laser pulses having a green laser wavelength, a laser spot diameter in a range of between about 50 μm and about 100 μm, and a power in a range from about 3 W to about 6 W, and wherein application of the laser output causes processed regions of the recessed aluminum surface to exhibit a second surface appearance that appears whiter than the first surface appearance, thereby causing the processed regions of the recessed aluminum surface to appear white to a human eye viewing the processed regions of the recessed aluminum surface.

23. A method of modifying the appearance of an aluminum surface, comprising:
forming a recess in an aluminum surface to provide a recessed aluminum surface exhibiting a first surface appearance; and
modifying the recessed aluminum surface by application of laser output to process separate regions of the recessed aluminum surface with about 30 to 70 laser pulses at a pulse repetition rate in a range from about 50 kHz to about 500 kHz to form separate recesses separated by a center-to-center distance between adjacent recesses in a range from about 30 μm to about 60 μm and having a depth in a range from about 5 μM to about 15 μm, wherein the laser output includes laser pulses having an infrared laser wavelength, a laser spot diameter in a range of between about 15 μm and about 40 μm, and a power in a range from about 1 W to about 10 W, and wherein application of the laser output causes processed regions of the recessed aluminum surface to exhibit a second surface appearance that appears whiter than the first surface appearance, thereby causing the processed regions of the recessed aluminum surface to appear white to a human eye viewing the processed regions of the recessed aluminum surface.
